(19) United States
(12) Patent Application Publication
(10) Pub. No.: US 2020/0377378 A1
(43) Pub. Date: Dec. 3, 2020

(54) DEVICE AND METHOD FOR CONDITIONING WATER IN A TANK

(71) Applicant: Heinz-Guenther FRANZ, Hamburg (DE)

(72) Inventor: Heinz-Guenther FRANZ, Hamburg (DE)

(21) Appl. No.: 16/888,699

(22) Filed: May 30, 2020

(30) Foreign Application Priority Data
May 31, 2019 (EP) 19177670.7

(51) Int. Cl. C02F 1/00; C02F 1/68

(52) U.S. Cl. CPC C02F 1/008; C02F 1/685; C02F 2103/42; C02F 2209/008; C02F 2201/005

(57) ABSTRACT

A device is provided for metering at least one water-quality chemical in a water tank (1). The device comprises a metering duct (14) with an outlet port (16), a metering unit (13) for metering the water-quality chemical through the metering duct (14) and a control unit (12) which is connected to the water-quality sensor (10) and controls the metering unit (13), wherein the metering unit (13) and the control unit (12) are received in a housing (19) and a supply (17) is receivable in the housing (19) or connectable thereto and a carrier (9a; 9b; 24), to which a water-quality sensor (10) and an outlet port (16) of the metering duct (14) are fixed, is designed for insertion into the water tank (1), such that the outlet port (16) of the metering duct (14) is located downstream of the water-quality sensor (10).

The present invention relates to a device for metering at least one water-quality chemical into a water tank, the device comprising at least one water-quality sensor, a metering duct with an outlet port, a metering unit for metering the water-quality chemical through the metering duct and a control unit which is connected to the water-quality sensor and controls the metering unit.

Such device is already known from DE 10138384 A1. DE 10138384 A1 describes a device for disinfection and sterilization of mixed water in a water tank inside a recirculation circuit. Mixed water is meant here to describe water that consists of overflow water (contaminated pool water that flows from a pool via an overflow channel into a water tank) and filling water (fresh water from the central drinking water supply). This mixed water is pumped by a recirculating pump to a water treatment system, where it is filtered, and then pumped back into the water tank. In such recirculation circuit, the contaminated pool water flows via the overflow channel from the pool into a water tank, where it is mixed with filling water to form mixed water. From there it is pumped by the recirculating pump through the mentioned water treatment system and is filtered in this process. Essential water parameters such as pH value, chlorine content, nitrate content, phosphate content (, . . . ) are determined by a water-quality sensor at the water treatment system outlet and, based on the measured values, one or more water-quality chemicals such as, e.g. chlorine (Cl⁻), nitrates (NO₃⁻), phosphates (PO₄³⁻) (, . . . ) are supplied via a metering duct having an outlet port to a pipeline system. The water-quality sensor determines the quantity of water-quality chemicals necessary. This water-quality sensor is located in the pipeline system and is positioned downstream of the water treatment system. The water-quality sensor measures the water parameters of the water into which it is immersed and transmits the measured values via electrical lines to a control unit. The control unit analyzes the measured values and controls a metering unit. The demand of water-quality chemicals determined by the control unit is then supplied by the metering unit through a connected metering duct having an outlet port located downstream of the water-quality sensor. The chemicals supplied are fed and mixed by a reaction mixer to the mixed water flowing through the pipeline system, which mixed water was filtered in the water treatment system.

Finally, the recirculating pump pumps the water back into the water tank, thus completing the described recirculation circuit. In the assembly of DE 10138384 A1 the mixed water and the added water-quality chemical are mixed by a reaction mixer. However, mixing the mixed water and the water-quality chemical in the pipeline system in no case results in an even distribution of the water-quality chemical in the entire water tank. In addition, the above-mentioned document describes a permanently installed pipeline system. Installation of this pipeline system at the water tank is costly. Once installed at a water tank, the system can be no longer, or only with great effort, used with another water tank model.

DE 10029568 A1 also discloses a water treatment process in a water tank as well as a measuring and control unit to ensure water quality. The recirculation process takes place in the same way as described in DE 10138384 A1. The only difference is that in DE 10029568 A1 the measuring and control unit is separated from the recirculation circuit. The demand of water-quality chemicals (Cl⁻, NO₃⁻, PO₄³⁻, . . . ) is not measured directly on the mixed water in the pipeline system of the recirculation circuit. Instead, the water tank has a separate drain port, through which contaminated pool water is discharged and examined. The water discharged through the drain for measuring water parameters (pH value, chlorine content, nitrate content, phosphate content, . . . ) is called sample water. In the measuring unit spaced and apart from the recirculation circuit, water-quality sensors measure these water parameters and determine the demand of water-quality chemicals. This demand is signaled to a control unit via electrical lines. The control unit stores target values for optimum water quality, as well as measured values measured by the water-quality sensors. Then, comparators and processors determine controlled variables which define the quantity of water-quality chemicals to be discharged by the outlet port of the metering duct into the mixed water hold in the water tank. The different locations of the measuring and control unit and the recirculation circuit increases the risk that the metering unit incorrectly supplies water-quality chemicals through the outlet port of the metering duct. If the water is insufficiently mixed in the pool, the sample water flowing through the drain to the water-quality sensors can potentially have a different water quality than contaminated pool water, which enters the water tank and thus the recirculation circuit via the overflow channel. In addition the water-quality sensor in the measuring unit measures the described sample water and not the mixed water obtained in the water tank, to which the water-quality chemical is added via the outlet port of the metering duct. The difference in water quality of sample water and mixed water also increases the risk of incorrectly supplying water-quality chemicals. Without connection between measuring unit and metering unit one further needs to manually input the required amount of water-quality chemical, which on the one hand increases the effort for the user and on the other hand increases the error rate in supplying water-quality chemicals. Furthermore, the additionally installed measuring and control loop results in increased space requirement for laying pipelines and electrical lines in addition to the pipes of the recirculation circuit.

In view of this it is an object of the invention to provide a reliable and at the same time simplified device for conditioning water in a water tank.

The invention is defined in claims 1 and 14. Advantageous embodiments are defined in the dependent claims.

The device comprises a water-quality sensor which is attached to a carrier and can be introduced into a water tank together with the carrier. The water-quality sensor is immersed into water flowing through the water tank and measures at least one essential water parameter (pH value, chlorine content, nitrate content, phosphate content, . . . ). In the following, reference is made to a water-quality sensor. However, in addition to multisensor embodiments, the sensor can also be realized as a sensor bundle for measuring several different water parameters.

In addition to the water-quality sensor, a metering duct is attached to the carrier of the device such that an outlet port of the metering duct is located downstream of the water-quality sensor. The metering duct enables to introduce one or more water-quality chemicals into the water in the water tank via the outlet port. This/These chemical(s) affect(s) at least one water parameter.

The other end of the metering duct is connected to a metering unit, which is directly connected to a control unit via electrical lines. The water-quality sensor in the device is also connected to this control unit via electrical lines.

During the circulation process of the entire water tank, a circulating pump sucks the water out of the water tank. Then it is filtered and finally pumped back into the water tank by the circulating pump. The described circulation circuit defines a stream current direction in the water tank.

The water-quality sensor determines at least one essential water parameter of the water flowing around the sensor in the water tank. Measured data are transmitted to the control unit via electrical lines. The control unit determines the demand of the at least one water-quality chemical from the at least one water parameter. The water-quality chemical(s) ensure(s) that a desired water quality is obtained in the water tank.

Once the demand of water-quality chemicals was determined by the control unit, the control unit controls the metering unit via electrical lines. The metering unit receives the demand of the water-quality chemicals and then introduces the required quantity to the water in the water tank via the metering duct having its outlet port downstream of the water-quality sensor.

The carrier can be mounted in the water tank permanently or detachably. Preferably, it is detachably connected to a part of the water tank, so that the carrier can be installed in the water tank for water conditioning, but can also be removed again later. A transition from a main part of the water tank to a suction region from which the aforementioned circulation pump sucks out water is ideal for positioning the carrier.

The device further comprises a housing in which the metering unit and the control unit are received. In addition, a supply tank for one or more water-quality chemicals can be received in the housing or can be connected to the housing to make the device more compact, wherein a connection is provided from the supply tank to the metering unit through a housing wall.

The main advantage of the device is that the carrier is detachably positioned in the water tank and thus only needs to be temporarily installed for water conditioning in the water tank. The device is preferably not permanently installed on the water tank. This advantage is promoted by the housing, which enables easy transport of the control unit, the metering unit and the supply tank. An optionally detachable connection between supply tank and housing further increases portability and allows a compact design of the housing, independently of the supply tank's capacity of water-quality chemicals.

Water-quality sensor and metering duct are fixed to the carrier and can be introduced into the water tank together with the carrier. This offers two major advantages. Due to the fixation on the carrier, the carrier to which the water-quality sensor and the outlet port of the metering duct are attached, can be placed in the water tank so that the outlet port of the metering duct is located downstream of the water-quality sensor. This avoids at all conditions contact between the freshly introduced water-quality chemical and the water-quality sensor when metering the water-quality chemical via the metering duct into the water in the water tank, and, thus, false measurement results. In an ideal embodiment, the water tank is divided into a main part and a relatively small suction region and the device is used in the division between these two regions, as already described. From the comparatively small suction region, water is sucked off more quickly (compared to the larger part of the water tank), which further reduces the risk of impairing measurement results by the added water-quality chemical. Furthermore, a very fast mixing of freshly added water-quality chemical and water in the water tank is obtainable.

In a preferred embodiment, the carrier is realized as a pipe with openings, which allows the metering duct and the water-quality sensor to be installed inside the pipe. On the one hand, this ensures the flow through the pipe and the associated flow around the water-quality sensor and, on the other hand, protects the components better against external influences due to the position inside of the pipe.

In another preferred embodiment, the carrier is designed as a pipe with an upper inlet and a lower outlet. This also ensures the flow and the associated flow around the water-quality sensor. In addition, a flow direction of the water from the water tank is specified.

The carrier may be provided with a fastening device in a further embodiment. This fastening device makes it possible to fix the carrier permanently or detachably in the water tank. Such a fastening device is implemented in various embodiments with a magnet, a hook and loop device, a suction cup, a pin, or a mechanical locking. Such fixing of the carrier in the water tank avoids slipping of the carrier and allows a detachable fixing of the carrier including the water-quality sensor and the outlet port of the metering duct. By avoiding the slipping of the carrier, it is prevented that the entered water-quality chemical contacts the water-quality sensor directly and, thus, impairs the measurement. At the same time the portability of the device remains still unaffected.

In a preferred embodiment, the device comprises a hybrid line combining the electrical line running from the water-quality sensor to the control unit and the metering duct running from the carrier fixed outlet port to the metering unit. In a further embodiment, this hybrid line is connected by a plug connection on the housing holding the control unit and the metering unit. This reduces the complexity of installation and facilitates transport of the device.

In addition, in another embodiment of the device, a display and an input device, in particular a start button, are attached to the housing. This allows the user to monitor the entire process of water quality measurement and introduction of the water-quality chemical and to intervene, if necessary, by specifying values or value ranges to be set. A further improvement is use of an App to specify or monitor values or value ranges to be set over a wireless connection to a portable data device such as, e.g. a mobile phone or a tablet.

The water tank is in particular a whirlpool tub having a pool region and an outlet region through which water flows to enter the circulation circuit. The water flows from the pool region into the outlet region and is then fed back into the pool region from there. The outlet region in whirlpool tubs is usually separated from the pool region by an overflow wall. In the outlet region there is a clear flow direction for the water streaming in the circulation circuit.

The device is designed to be portable, i.e. the housing and the carrier are each portable and connected to each other via the metering duct, so that the water-quality chemical can be conveyed from the housing to the outlet port of the metering duct, which is located at the portable carrier. The portable carrier is designed to be inserted into the outlet region such that the sensor end of the water-quality sensor is upstream of the drain end of the metering duct. This ensures that the water-quality sensor measures the water quality before the water-quality chemical is added from the outlet port of the metering duct. Thus, the measurement of the water quality is not interfered with.

The portable carrier and the portable housing achieve an overall portable device that is placed next to the whirlpool tub for only one conditioning process. The rest of the time, the device it is not permanently provided in the region of the whirlpool tub. To this end, it is useful if the device comprises its own power supply, for example a battery, or a connection to external power supply. The housing comprises a base for resting and a handle. The housing thus remains outside the whirlpool tub assembly and only the portable carrier is placed in the outlet region. As already described, the carrier is connected to the portable housing via the metering duct and, if necessary, via corresponding connection lines for the water-quality sensor.

The invention enables a very simple method for conditioning water in the whirlpool tub. The aspects of the device described above equally relate to the method according to which the device is provided and used. For applying the method, the portable housing is, in particular, arranged close to the whirlpool tub, wherein the distance to the outlet region is not greater than the length of the metering duct. This ensures that the portable carrier, which is mechanically coupled to the portable housing via the metering duct, can be conveniently inserted into the outlet region in order to measure the water quality with the sensor installed at the carrier and to appropriately add the water-quality chemical through the outlet port of the metering duct.

After carrying out this method, the processor, which is provided in the portable housing, generates a signal based on the water quality measured by the water-quality sensor, which signal indicates the completion of the conditioning process. The carrier can then be removed from the outlet region and the portable housing can be removed from the whirlpool tub until water conditioning is required again, for example a few days later.

In the following, the invention is explained in more detail by way of example with reference to the drawings. There is shown in:

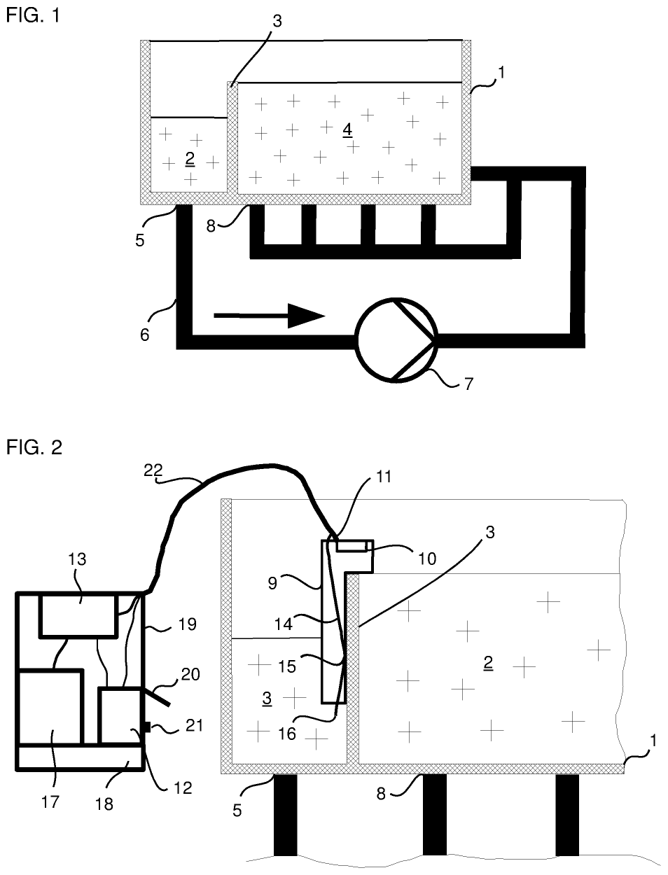

FIG. 1 a recirculation process in a water tank according to the state of the art,

FIG. 2 a scheme of the device,

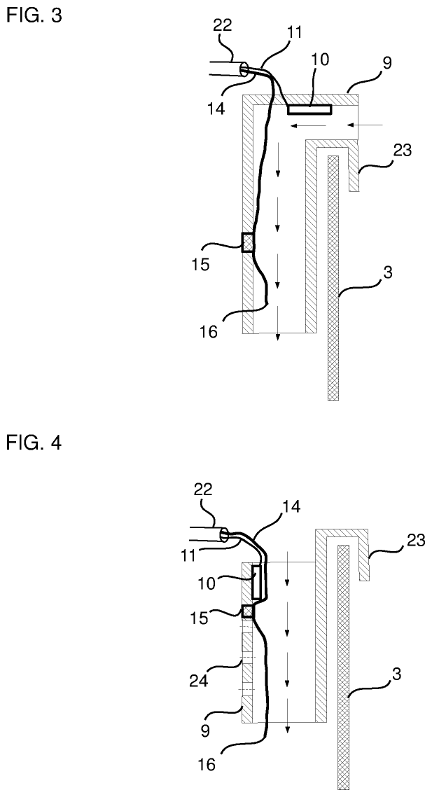

FIG. 3 a possibility of fixing a carrier formed as a flow pipe of the device to an overflow wall of the water tank,

FIG. 4 the flow pipe designed straight, and

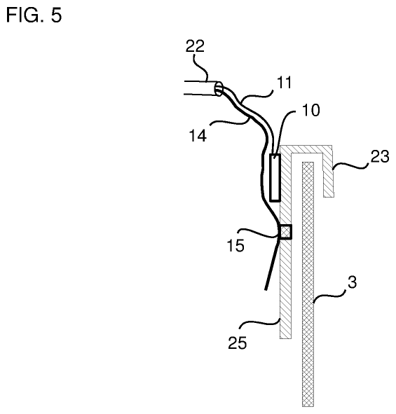

FIG. 5 the carrier designed as a holder.

FIG. 1 shows schematically a circulation process in a water tank 1. The water tank 1 holds water. Water in a suction region 2 is separated by an overflow wall 3 from water in a main part 4. This suction region is connected to a pump 7 via a suction opening 5 and a line system 6. Outlet nozzles 8, in turn, connect the line system 6 with the main part 4 of the water tank 1.

When the water tank 1 is operating fully, the pump 7 is switched on. Accordingly, the pump 7 circulates all the water in a relatively short time, e.g. within one minute from the suction opening 5 to the outlet nozzles 8. When activated, the pump 7 causes the water to flow over the overflow wall 3 and into the suction region 2. From the suction region 2 the pump 7 sucks the water through the suction opening 5 into the line system 6. From there, the pump 7 pumps the water through the outlet nozzles 8 back into the main part 4 to the remaining water. It should be noted that the design of water tank 1 is merely exemplary. The pump 7 pumps water out of the suction region 2 for circulation. Details of feeding the water to the suction region 2, in particular the division into main part 4 and suction region 2 by the overflow wall 3, are optional.

In FIG. 2 the suction region 2 and the overflow wall 3 are shown enlarged, with a schematic representation of a device for metering a water-quality chemical. An angled flow pipe 9a is detachably fixed to the overflow wall 3. The angled flow pipe 9a acts as a carrier for at least one water-quality sensor 10, which is received in the pipe and connected to a control unit 12 via an electrical line 11 or wireless. This water-quality sensor measures at least one specific water parameter (pH value, chlorine content, nitrate content, phosphate content, . . . ) in order to transmit demand for at least one water-quality chemical to the control unit 12. The control unit 12 controls a metering unit 13. Further, a metering duct 14 connected to the metering unit 13 extends through the angled flow pipe 9a, which metering duct is fixed to the angled flow pipe 9a by a fixation 15 so that an outlet port 16 of the metering duct 14 is at a fixed distance from the water-quality sensor 10. The metering duct 14 is connected to the metering unit 13, which is connected by an unspecified electrical line (without reference numeral in the figure) or wirelessly to the control unit 12 and by a fluid line (without reference numeral in the figure) to a supply tank 17 holding the individual water-quality chemicals. Control unit 12, metering unit 13, supply tank 17 holding the water-quality chemicals and a rechargeable battery 18 are confined in a housing 19. In addition, on the housing there is provided a display 20 and an input device, in particular comprising a start button 21, or alternatively a wireless connection to an external data device, e.g. a mobile phone or tablet.

In the circulation process, water also flows through the angled flow pipe 9a, thus coming into contact with the water-quality sensor 10 located in the pipe. The water washes around the water-quality sensor 10 and the sensor transmits measured water parameters via the electrical line 11 to the control unit 12. The control unit 12 controls in closed-loop fashion the metering unit 13 to feed water quality chemicals via the metering duct 14 and out of the outlet port 16 located downstream of the water-quality sensor 10. The power supply of the control unit and the metering unit is ensured by rechargeable battery 18 or by connection to power line. The device is portable; control unit 12, metering unit 13 and rechargeable battery 18 (if present) are located in a housing 19. The housing is connected to the angled flow pipe 9a, optionally via a plug connection to be detached later. The display 20 and the input device with start button 21 enable the user to actively intervene in the process.

The metering duct 14 and the electrical line 11 from the water-quality sensor 10 to the control unit 12 are optionally combined to a hybrid line 22. The metering duct 14 including the outlet port 16 fixed to the angled flow pipe 9a ensures that output of the water-quality chemical always occurs downstream of the water-quality sensor 10. Due to spatial separation of outlet port 16 and water-quality sensor 10, which are fixed to the carrier being designed, in this embodiment, as a flow pipe, the metered-in water-quality chemicals cannot immediately come into contact with the part of the water that subsequently reaches the water-quality sensor 10. Otherwise the measurement values would be interfered with. Due to arrangement of the outlet port 16 downstream of the water-quality sensor 10 and increased flow velocity in the suction region 2, unbiased measurement data are continuously obtained and an improved water quality is achieved.

FIG. 3 shows the carrier in a further embodiment. Here, it is an angled flow pipe 9a suspended with a collar 23 over the overflow wall 3 dividing the water tank 1 from the suction region 2. The water flowing in the described circulation process bathes the the water-quality sensor 10, which is connected to the electrical line 11. The latter is optionally combined with the metering duct 14 in the hybrid line 22. The outlet port 16 of the metering duct is located downstream of the water-quality sensor 10. The position of the outlet port 16 downstream of the water-quality sensor 10 is secured by the fixation 15.

FIG. 3 also demonstrates the portability of the device. The carrier (e.g. in FIG. 3 the angled flow pipe 9a) is detachably fixed to be located in the suction region 2, e.g. As shown in FIG. 3, its collar 23 hangs over the overflow wall 3. This ensures easy installation and removal of the carrier and thus, for example, that the device can be used on several water tanks, or that it can only be installed at certain measurement intervals (once per week/month, etc.). Preferably, the carrier is installed only for water conditioning and not permanently. Other fixing means are also possible, e.g. magnet, suction cup, pin, hook and loop devices or mechanical locking.

In FIGS. 2 and 3 the carrier is realized as an angled flow pipe 9a. However, this is by no means mandatory. The carrier can also be realized differently, for example as a straight flow pipe 9b fixed to the overflow wall 3, as shown in FIG. 4. The water-quality sensor 10 is also here bathed in flowing water and sends the measured data via the electrical line 11 to the control unit 12. The metering duct 14 is fixed to the flow pipe 9, with its outlet port 16 downstream of the water-quality sensor 10. Metering duct 14 and electrical line 11 are advantageously combined in the combination line 22.

Whether the carrier is embodied angled as in FIGS. 2 and 3 or straight or in other geometries, does not change the other features of the device. The process occurs exactly as described in FIG. 2. There is also no change in the spatial relationships compared to an angled carrier embodiment.

In FIG. 5 the carrier is designed as rod- or plate-shaped holder 24. This holder 24 is suspended into the suction region 2 with the collar 23 extending over the overflow wall 3. Water flows around the water-quality sensor 10, which transmits its measured values via the electrical line 11. The metering duct 14 is fixed to the holder 24, wherein again the outlet port 16 is located downstream of the water-quality sensor 10. Metering duct 14 and electrical line 11 are combined in the combination line 22 as shown in FIGS. 3 and 4.

FIG. 5 demonstrates that a flow pipe 9a; 9b is not necessarily required. A holder 24 is sufficient, which allows to insert water-quality sensor 10 into the flow and to fix outlet port 16 of metering duct 14 downstream the water-quality sensor 10. As shown in FIGS. 3 and 4, the holder 24 can be fastened either by a flange 23, as shown in FIG. 5, or by magnet, suction cup, pin, a hook and loop device or by mechanical locking.

The suction region embodies an outlet region of the water tank 1, which can be a whirlpool tub. The control unit 12 particularly includes a processor which carries out the corresponding data processing and signal processing. The metering unit 13 particularly includes a controllable metering valve. It has a valve inlet where the water-quality chemical is supplied and a valve outlet which is in fluid connection with the metering duct. It is suitably controlled by the processor.

The portable housing has a carrying handle and a base that allows the housing to be placed near the whirlpool tub.

Overall, the device is designed portable, i.e. both the housing and the carrier are portable.

1. A portable device for conditioning water in a whirlpool tub comprising a pool region and an outlet region separated therefrom by an overflow wall through which outlet region water from the pool region flows in a recirculation circuit, the device comprising:
at least one water-quality sensor configured to output a water quality signal,
at least one metering duct with an outlet port
at least one controllable metering valve comprising a valve inlet for a water-quality chemical and a valve outlet which is in fluid connection with the metering duct,
at least one processor configured to receive the water quality signal and to control the metering valve based on the water quality signal,
a portable housing in which the metering valve and processor are received and which comprises either a tank for the water-quality chemical or a connection port for fluidic connection of the tank,
a portable carrier to which the water-quality sensor and the outlet port of the metering duct are fixed and which is designed for detachable insertion into the outlet region, such that the outlet port of the metering duct is located downstream of the water-quality sensor.

2. The portable device according to claim 1, wherein the portable carrier includes a tubular portion with an inlet and an outlet, wherein the water-quality sensor and the outlet port are located between the inlet and outlet.

3. The portable device according to claim 1, wherein the portable carrier has a hook for suspending on the overflow wall.

4. The portable device according to claim 1, wherein the portable carrier comprises a magnet for fixing the carrier to the overflow wall.

5. The portable device according to claim 1, wherein the portable carrier comprises a hook and loop connection for fixing the carrier to the overflow wall.

6. The portable device according to claim 1, wherein the portable carrier has a suction cup for fixing the carrier to the overflow wall.

7. The portable device according to claim 1, wherein the portable carrier has a pin for fixing the carrier to the overflow wall.

8. The portable device according to claim 1, wherein the portable carrier comprises a buoyancy body and is designed for buoyant insertion into the outlet region.

9. The portable device according to claim 1, wherein the water-quality sensor comprises an electrical connection line and the device further comprises a hybrid line combining the metering duct and the electrical connection line.

10. The portable device according to claim 1, wherein the portable housing comprises a plug connection for the metering duct leading to the portable carrier.

11. The portable device according to claim 1, wherein the portable housing comprises a battery or a power connection line for supplying power to the portable device.

12. The portable device according to claim 1, wherein the portable housing comprises a display and an input device, in particular a start button.

13. The portable device according to claim 1, wherein the device further comprises a transmitting and receiving circuit for radio communication with an external processor in order to specify values or value ranges to be set and/or to monitor actual values.

14. The portable device according to claim 1, wherein the portable comprises a carrying handle and a base for placing the housing.

15. A method for conditioning water in a whirlpool tub including a pool region and an outlet region separated therefrom by an overflow wall through which outlet region water from the pool area region flows in a recirculation circuit, the method comprising the steps of:
providing a portable device which comprises:
at least one water-quality sensor configured to output a water quality signal,
at least one metering duct with a length and an outlet port,
at least one controllable metering valve comprising a valve inlet for a water-quality chemical and a valve outlet which is in fluid connection with the metering duct,
at least one processor configured to receive the water quality signal and to control the metering valve based on the water quality signal,
a portable housing in which the metering valve and processor are received and which comprises either a tank for the water-quality chemical or a connection port for fluidic connection of the tank,
a portable carrier to which the water-quality sensor and the outlet port of the metering duct are fixed,
arranging the portable housing on the whirlpool tub and at a distance from the outlet region that is less than the length of the metering duct,
inserting the carrier in the outlet region, such that the outlet port of the metering duct is located downstream of the water-quality sensor,
activating the processor to measure a water quality and metering in the water-quality chemical for condition the water.

16. The method according to claim 15, wherein the inserting step comprises hooking the portable carrier to the overflow wall.

17. The method according to claim 15, wherein the inserting step comprises fixing the portable carrier to the overflow wall by means of magnetic force.

18. The method according to claim 15, wherein the inserting step comprises fixing the portable carrier to the overflow wall by means of a hook and loop closure.

19. The method according to claim 15, wherein the inserting step comprises fixing the portable carrier to the overflow wall by means of a suction cup.

20. The method according to claim 15, wherein the inserting step comprises fixing the portable carrier to the overflow wall by means of a mechanical locking or clamping means.

21. The method according to claim 15, wherein the portable carrier is provided with a buoyancy body and is buoyantly inserted into the outlet region.

22. The method according to claim 15, further comprising the step of: generating and outputting a conditioning completion signal by means of the processor and subsequently removing the portable carrier from the outlet region and the portable housing from the whirlpool tub.
